(19) United States
(12) Patent Application Publication
(10) Pub. No.: US 2020/0206958 A1
(43) Pub. Date: Jul. 2, 2020

(54) JOINT AND ROBOT HAVING THE SAME

(71) Applicant: Ubtech Robotics Corp Ltd, Shenzhen (CN)

(72) Inventors: Youjun Xiong, Shenzhen (CN); Meichun Liu, Shenzhen (CN); Youpeng Li, Shenzhen (CN)

(21) Appl. No.: 16/583,273

(22) Filed: Sep. 26, 2019

(30) Foreign Application Priority Data
Dec. 29, 2018 (CN) 201811636439.8
Dec. 29, 2018 (CN) 201811642996.0

(51) Int. Cl. B25J 17/00

(52) U.S. Cl. CPC B25J 17/00

(57) ABSTRACT

A joint of a robot includes a first servo assembly having a first housing and a first servo arranged within the first housing and comprising an output shaft; an ankle support having two ends rotatably connected to the first housing; and a bearing assembly to connect one of the two ends of the ankle support to the first housing. The bearing assembly includes a first connecting member fixed to the first housing, a second connecting member fixed to the one of the two ends of the ankle support, and a bearing to rotatably connect the first connecting member to the second connecting member. The other one of the two ends of the ankle support is connected to the output shaft of the first servo.

### CROSS REFERENCE TO RELATED APPLICATIONS

This application claims priority to Chinese Patent Application Nos. 201811642996.0 and 201811636439.8. both filed Dec. 29, 2018. which are hereby incorporated by reference herein as if set forth in its entirety.

### BACKGROUND

### 1. Technical Field

The present disclosure generally relates to robots, and particularly to a joint and a robot including the joint.

### 2. Description of Related Art

Humanoid robots are known and can imitate human actions. For example, humanoid robots include ankle joints that enable eversion/inversion and dorsiflexion/plantarflexion of their feet. Some conventional ankle joints include bearings, a shaft and an actuating assembly (i.e. a servo). Although conventional ankle joints can meet basic needs, it is desirable and useful to provide a new ankle joint for use in a robot.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a front view of a leg of a robot according to an embodiment.

FIG. 2 is side view of the leg of FIG. 1.

FIG. 3 is an isometric view of the leg of FIG 1.

FIG. 4 is isometric exploded view of the leg of FIG. 1.

FIG. 5 is isometric exploded view showing a first servo and a bearing assembly.

FIG. 6 is similar to FIG. 5, but viewed from a different perspective.

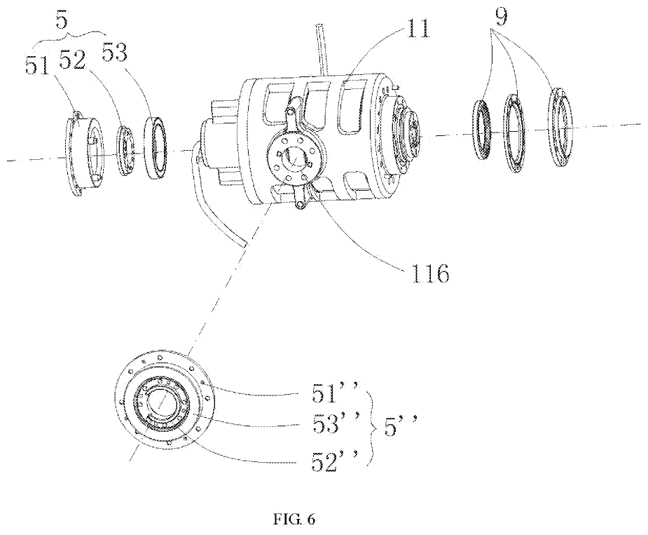

FIG. 7 is a cross-sectional view of the leg of FIG. 1, taken along line A-A.

FIG. 8 is an enlarged view of the circled portion of FIG. 7.

FIG. 9 is isometric exploded view of a bearing assembly of the leg of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

The terms “upper”, “lower”, “left” and “right”, indicating the orientational or positional relationship based on the orientational or positional relationship shown in the drawings, are merely for convenience of description, but are not intended to indicate or imply that the device or elements must have a particular orientation or be constructed and operated in a particular orientation, and therefore should not be construed as limiting the present invention. The terms “first” and “second” are used for descriptive purposes only and are not to be construed as indicating or implying relative importance or implicitly indicating the number of technical features. The meaning of “multiple” is two or more, unless expressly stated otherwise.

The present disclosure provides a joint 100 of a robot. In one embodiment, the joint 100 connects a foot 300 to a leg 200. In other embodiments, the joint 100 may be used to connect an arm to a body of the robot.

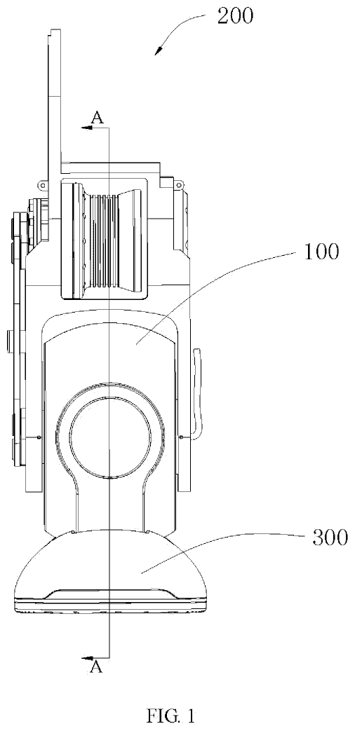

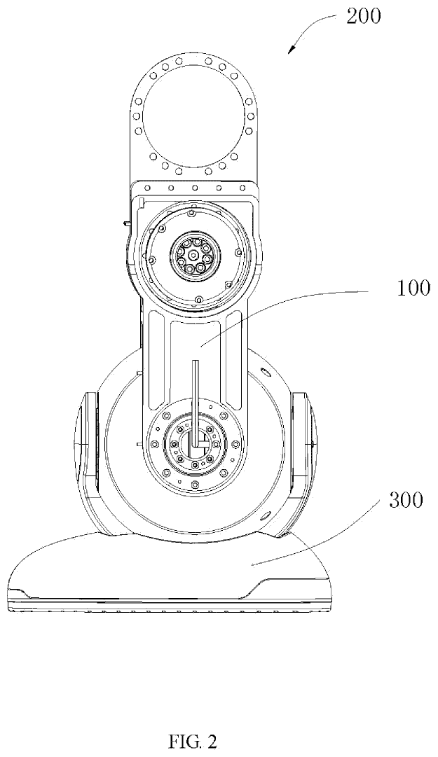

Referring to FIGS. 1-4, in one embodiment, a linear joint 100 includes a first servo assembly 1 and an ankle support 2 rotatably connected to the servo assembly 1. The foot 300 is connected to the ankle support 2 and can rotate together with the ankle support 2 with respect to the first servo assembly 1 about a first rotation axis. The first servo assembly 1 is rotatably connected to a mounting member 3 of the leg 200. The leg 200 can rotate with respect to the first servo assembly 1 about a second rotation axis that is perpendicular to the first rotation axis. With such a configuration, the foot 300 can rotate with respect to the leg 200 about two axes, which can simulate eversion/inversion and dorsiflexion/plantarflexion of a human foot.

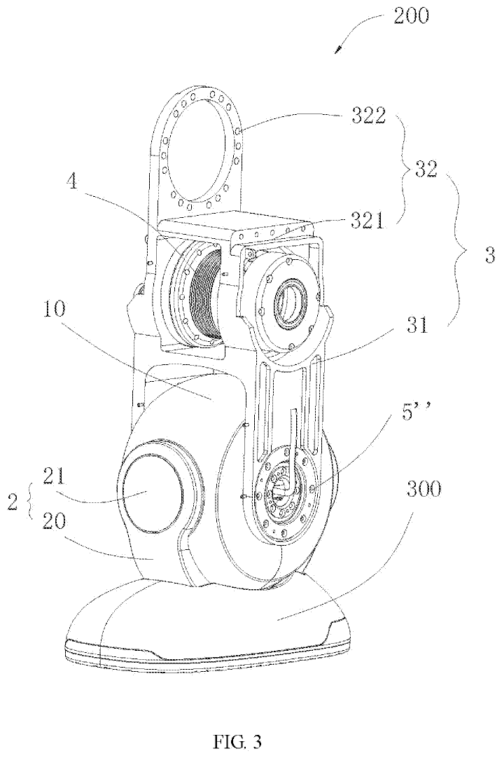

Referring to FIGS. 3-5, in one embodiment, the first servo assembly 1 includes a first housing 11 and a first servo 12 arranged in the first housing 11. The first servo 12 has an output shaft 121 protruding from an end of the first housing 11. One end of the ankle support 2 is rotatably connected to the output shaft 121 through a connecting member 9. An opposite end of the ankle support 2 is rotatably connected to an end of the first servo assembly 1 opposite the output shaft 121. In the embodiment, the opposite end of the ankle support 2 is rotatably connected to the first servo assembly 1 through a bearing assembly 5.

In one embodiment, the bearing assembly 5 includes a first connecting member 52 fixed to the first housing 11 at the end opposite the output shaft 121, a second connecting member 51 fixed to the ankle support 2, and a bearing 53 that rotatably connects the first connecting member 52 to the second connecting member 51. The second connecting member 51 can rotate with respect to the first connecting member 52 through the bearing 53, thereby achieving the rotation of the ankle support 2 relative to the first housing 11. That is, the ankle support 2 is rotatable relative to the first servo assembly 1.

With such a configuration, the bearing 53 is arranged between the connecting members 51 and 52, with its axial and radial movement restricted. As a result, the output stability of the output shaft 121 of the first servo 12 is improved, and the service life of the first servo 12 is improved.

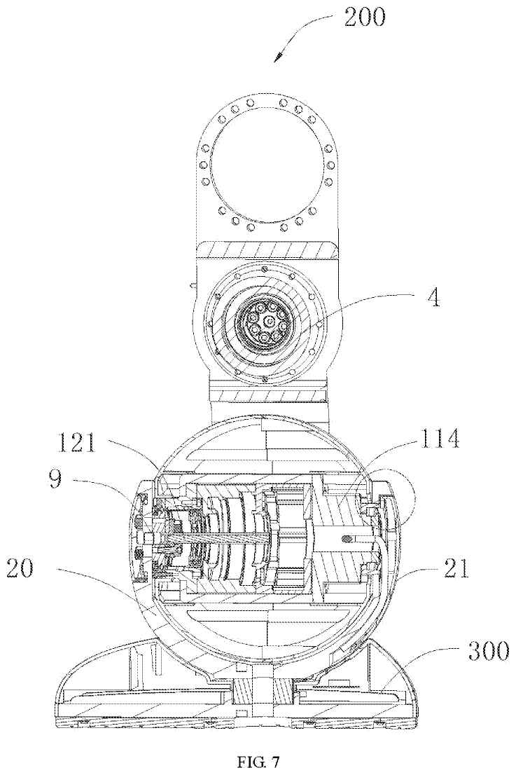

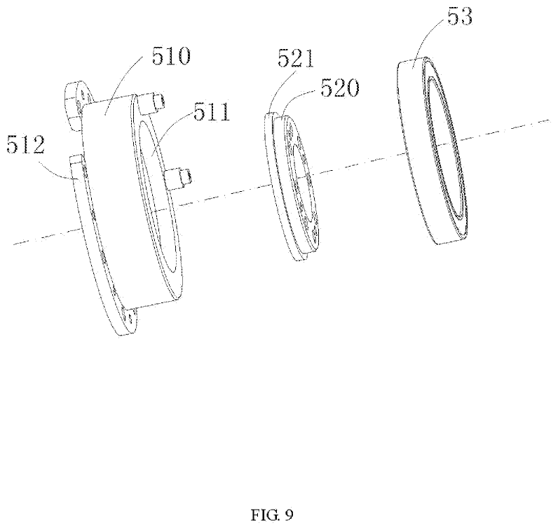

Referring to FIGS. 7-9, in one embodiment, the connecting member 51 includes a main body 510 and an inner Flange 511 protruding radially inwardly from an inner lateral surface thereof. The connecting member 52 includes a main body 520 and a flange 521 protruding radially outwardly from a lateral surface thereof. The hearing 53 is radially sandwiched between the main bodies 510 and 520 and axially sandwiched between the flanges 511 and 521. As result, axial and radial movement of the bearing 53 is prevented.

In one embodiment, the connecting member 51 further includes an outer flange 512 protruding radially outwardly from an outer lateral surface thereof at a side opposite the inner flange 511. The third flange is fixed to one end of the ankle support 2. The flange 521 of the connecting member 52 is connected to the first housing 11.

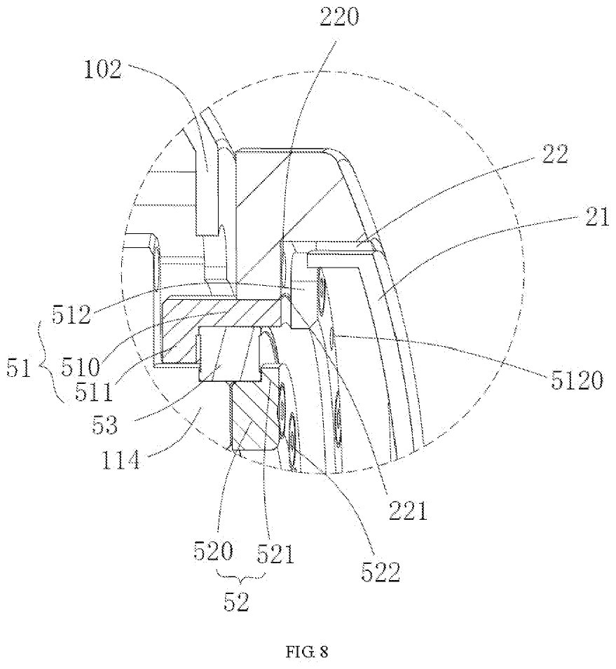

Referring to FIGS. 7 and 8, in one embodiment, one end of the ankle support 2 defines a receiving space 22, and a through hole 221 is defined in a bottom of the receiving space 22. The connecting member 51 is fixed to the bottom of the receiving space 22. The flange 512 of the connecting member defines a number of threaded holes 5120, and the ankle support 2 defines a number of mounting holes 220 arranged and sized according to the threaded holes 5120. In the embodiment, the mounting holes 220 are defined in the bottom of the receiving space 22 and are threaded holes, which allows screws to be screwed into the mounting holes 220 and the threaded holes 5120, thereby connecting the connecting member 51 to the bottom of the receiving space 22. It should be noted that the threaded holes 5120 may be replaced with through holes without internal threads.

The ankle support 2 further includes an end cap 21 covering the receiving space 22 to improve overall aesthetics. The main body 510 of the connecting member 51, the connecting member 52 and the bearing 53 are all located in the through hole 221 defined in the bottom of the receiving space 22.

In one embodiment, the first housing 11 includes a mounting portion 111 opposite the output shaft 121 of the first servo 12. The connecting member 52 is fixed to the mounting portion 111, thereby connecting the first housing 11 to the bearing assembly 5.

In the embodiment, the connecting member 52 defines a number of threaded holes 522 extending axially through the main body 520. The mounting portion 111 defines a number of mounting holes arranged according to the threaded holes 522. The mounting holes are threaded holes, which allows screws to be screwed into the mounting holes and the threaded holes 522, thereby connecting the connecting member 52 to the first housing 11.

When the bearing assembly 5 is assembled, the bearing 53 is first pressed into the connecting member 51, and then the connecting member 51 is fixed to the ankle support 2. The connecting member 52 is finally pressed into the bearing 53.

It should be noted that the bearing assembly 5 can be applied in other locations to rotatably connect two components together.

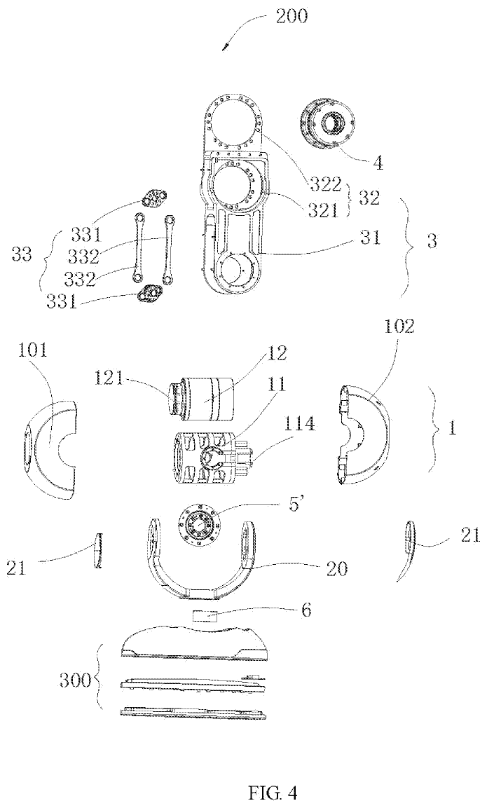

Referring again to FIGS. 3 and 4, in one embodiment, the mounting member 3 of the leg 200 is rotatably connected to the first housing 11 through two bearing assemblies 5. The mounting member 3 and the ankle support 2 are arranged in such a way that the rotation axis about which the first housing 11 rotates with respect to the mounting member 3 is substantially perpendicular to the rotation axis about which the first housing 11 rotates with respect to the ankle support 2, thereby allowing the foot 300 to have two rotational degrees of freedom.

Referring again to FIGS. 3 and 4, in one embodiment, the mounting member 3 includes a base 31 connected to the first housing 11, a servo mounting portion 321 arranged on the top of the base 31, and a connecting portion 322 arranged on the top of the servo mounting portion 321. The servo mounting portion 321 is used to mount thereon a second servo assembly 4 to drive the leg 200 to rotate with respect to the first housing 11. The base 31 is U-shaped and includes two vertical mounting walls 311 that are spaced apart from each other. The first housing 11 is rotatably connected to the two mounting walls, in the embodiment, the first housing 11 is rotatably connected to the mounting walls through hearing assemblies 5′ and 5″.

Each of the bearing assemblies 5′ and 5′ are the same as the bearing assembly 5. The connecting member 51′ of the bearing assembly 5″ is fixed to the base 31, and the connecting member 52″ is fixed to a mounting portion 116 protruding from a lateral surface of the first housing 11. The bearing 53″ is located between the connecting members 51″ and 52″. The connecting members 51 and 52 and bearing 53″ are respectively the same as the connecting members 51 and 52 and bearing 53, which will not repeat here.

The connecting member 3 further includes a linkage bar assembly 33 having one end rotatably connected to the output shaft 121 of the second servo assembly 4 through a rotation output member. The rotation outputted by the output shaft 121 of the second servo assembly 4 can be transmitted to the linkage bar assembly 33. The linkage bar assembly 33 further includes an opposite end connected tot the connecting member 52.

Referring to FIG. 4, in one embodiment, the linkage bar assembly 33 includes two transmitting members 331 and two linkage bars 332. One of the transmitting members 331 is connected to the output shaft 121 of the second servo assembly 4, the other one is connected to the first housing 11. The two linkage bars 332 are parallel to each other and their opposite ends are respectively connected to the two transmitting members 331.

In one embodiment, the transmitting member 331 is rotatably connected to the mounting portion 116 on the lateral surface of the first housing 11 through a bearing assembly 5′. In this case, three bearing assemblies 5, 5′ and 5″ are used to rotatably connect the first housing 11 to other components. It is also possible to adopt a simpler method, as long as the transmitting member 331 is driven to rotate the first housing 11. In this case, two bearing assemblies 5 and 5′ are used to connect the first servo assembly 1 to other components.

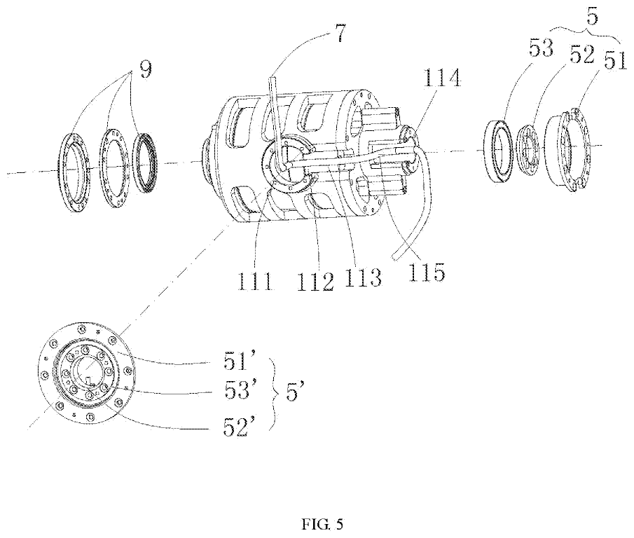

Referring to FIG. 5, in one embodiment, the mounting portion 114 is hollow and defines a groove 115 in a lateral surface thereof. The groove 115 extends axially from an end surface of the mounting portion 114 toward the other end surface. The groove 115 extends radially from the outer lateral surface of the mounting portion 114 to the inner lateral surface thereof. The mounting portion 111 is hollow and defines an opening 112 through which a cable 7 is able to pass and extend through the groove 115 and into the interior of the mounting portion 114. In the embodiment, the first housing 11 is further provided with a recess 113 extending from the opening 112 toward the mounting portion 114. The recess 113 receives the cable 7 after it passes through the opening 112 and extend toward the mounting portion 114. The mounting portion 111 with the opening 112, the first housing with the recess 113 and the mounting portion 144 with the groove 115 constitute a cable guiding structure. With such a cable guiding structure, the cable 7 will not be excessively twisted due to the rotation of the first servo 12, and the damage of the cable 7 is avoided.

Referring again to FIG. 4, in one embodiment, the first servo assembly 1 further includes a casing 10 that includes a first casing half 101 and a second casing half 102 that are connected to each other. The first casing half 101 is fixed to the first housing 11 at an end adjacent to the output shaft 121. The second casing half 102 is fixed to the first housing 11 at an end opposite the first casing half 101. The casing 10 is rotatable with the first housing 11.

In one embodiment, a robot includes a leg 200, a foot 300 and a joint as described above to connect the foot 300 to the leg 200.

The first servo assembly 1 and the ankle support 2, as well as the first servo assembly 1 and the mounting member 3 of the leg 200 are connected to each other by bearing assemblies. With the abovementioned bearing assemblies, axial and radial movement of the bearing 53 is prevented, which can improve the flexibility and consistency of the movement of the joint of the robot and increase the service life the servo.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A joint of a robot comprising:
a first servo assembly comprising a first housing and a first servo arranged within the first housing and comprising an output shaft;
an ankle support comprising two ends rotatably connected to the first housing; and
a bearing assembly configured to connect one of the two ends of the ankle support to the first housing, the hearing assembly comprising a first connecting member fixed to the first housing, a second connecting member fixed to the one of the two ends of the ankle support, and a bearing configured to rotatably connect the first connecting member to the second connecting member;
wherein the other one of the two ends of the ankle support is connected to the output shaft of the first servo.

2. The joint according to claim 1, wherein the first connecting member comprises a first main body and a first flange protruding radially outwardly from a lateral surface thereof, the second connecting member comprises a second main body and a second flange protruding radially inwardly from an inner lateral surface thereof, and the bearing is radially sandwiched between the first main body and the second main body and axially sandwiched between the first flange and the second flange.

3. The joint according to claim 2, wherein the second connecting member further comprises a third flange protruding radially outwardly from an outer lateral surface thereof at a side opposite the second flange, the third flange is fixed to the one of the two ends of the ankle support.

4. The joint according to claim 3, wherein the third flange defines a plurality of threaded holes, and the ankle support defines a plurality of mounting holes arranged according to the threaded holes.

5. The joint according to claim 2, wherein the first connecting member defines a plurality of threaded holes extending axially through the first main body, the first housing comprising a mounting portion opposite the output shaft of the first servo, the mounting portion defines a plurality of mounting holes arranged according to the threaded holes.

6. The joint according to claim 1, wherein the one of the two ends of the ankle support defines a through hole, and the bearing assembly is partly received in the through hole.

7. The joint according to claim 6, wherein the one of the two ends of the ankle support defines a receiving space, the through hole is defined in a bottom of the receiving space, and the second connecting member is fixed to the bottom of the receiving space.

8. The joint according to claim 7, further comprising an end cap covering the receiving space.

9. A robot comprising:
a leg;
a foot; and
a joint configured to connect the foot to the leg, the joint comprising:
a first servo assembly comprising a first housing and a first servo arranged within the first housing and comprising an output shaft;
an ankle support comprising two ends rotatably connected to the first housing; and
a bearing assembly configured to connect one of the two ends of the ankle support to the first housing, the bearing assembly comprising a first connecting member fixed to the first housing, a second connecting member fixed to the one of the two ends of the ankle support, and a bearing configured to rotatably connect the first connecting member to the second connecting member;
wherein the other one of the two ends of the ankle support is connected to the output shaft of the first servo.

10. The robot according to claim 9, wherein the leg comprises a mounting member comprising two mounting walls that are spaced apart from each other, the first housing is rotatably connected to the two mounting walls.

11. The robot according to claim 9, wherein the first housing comprising a first mounting portion opposite the output shaft of the first servo and a second mounting portion, the first mounting portion is hollow and defines a first groove in a lateral surface thereof, the first connecting member is connected to the first mounting portion, the leg is rotatably connected to the second mounting portion, the second mounting portion is hollow and defines an opening through which a cable is able to pass and extend through the first groove and into the interior of the first mounting portion.
